(19) United States
(12) Patent Application Publication
(10) Pub. No.: US 2021/0219394 A1
(43) Pub. Date: Jul. 15, 2021

(54) COLLIMATING TORCH USING SELECTIVE MATRIX ILLUMINATION

(71) Applicant: LUMILEDS LLC, San Jose, CA (US)

(72) Inventors: Arjen van der Sijde, Eindhoven (NL); Nicola Bettina Pfeffer, Eindhoven (NL); Quint van Voorst Vader, Eindhoven (NL)

(73) Assignee: LUMILEDS LLC, San Jose, CA (US)

(21) Appl. No.: 17/125,871

(22) Filed: Dec. 17, 2020

Related U.S. Application Data
(60) Provisional application No. 62/959,618, filed on Jan. 10, 2020.

(51) Int. Cl. H05B 45/10; F21L 4/02; H05B 47/125; H05B 47/17

(52) U.S. Cl. CPC H05B 45/10; F21L 4/027; F21Y 2115/10; H05B 47/17; H05B 47/125

(57) ABSTRACT

A lighting apparatus and method of controlling a lighting apparatus are described. A power supply capable of supplying an amount of power is connected to an array of light emitting elements capable of illuminating an area in response to the supplied amount of power. At least some light emitting elements can have independently controllable illumination intensity, with the array of light emitting elements being switchable between a first mode in which each member of the array of light emitting elements received the supplied amount of power and provides a broadly collimated beam, and second mode where a subset of the array of light emitting elements receive the supplied amount of power and provides a narrower collimated beam.

### CROSS-REFERENCE TO RELATED APPLICATIONS

This application claims benefit of priority to U.S. Provisional Patent Application 62/959,618 filed Jan. 10, 2019, which is incorporated herein by reference in its entirety.

### TECHNICAL FIELD

The present disclosure relates to selective collimation of illumination illuminating light beams. Some embodiments relate to segmented or matrix LEDs suitable for flashlights or other adaptively directed light sources.

### BACKGROUND

The use of LEDs for a wide variety of lighting has exploded in the last decade. The high efficiency of LEDs compared to conventional filament lightbulbs and florescent lights, as well as the improved manufacturing capability has led to their vastly increased use in room lighting. The compact nature, low power, and controllability of LEDs has likewise led to their use as light sources in a variety of electronic devices such as cameras and smart phones, as well as handheld devices such as flashlights.

Unfortunately, in mobile devices such smartphone, tablets, torches or flashlights, the maximum current delivered by the battery is in general limited by battery discharge limits and device thermal constraints. Typically, thermal constraints come from limited space and area available in a device supporting a LED lighting unit. Small device area can result in limited heatsinking or thermal transfer needed to prevent damage to electronics. Maximum DC currents can also be limited to a range of about 100 mA to 200 mA, putting restrictive limits on torch light output.

### BRIEF DESCRIPTION OF THE DRAWINGS

FIG. 1A shows a 7×7 LED array operated in various collimation modes.

FIG. 1B is a graph illustrating improved illumination for a 7×7 LED array operated in various collimation modes.

FIG. 1C shows a switching a device between broad and narrow collimation modes.

FIG. 1D shows in cross section one embodiment of an LED pixel array with associated optics for far field mixing.

FIG. 2 shows circuitry in a light source in accordance with some embodiments.

FIGS. 3A-3B show LED source matrixes in accordance with some embodiments.

FIG. 4 shows an example of a flowchart of using the light source in accordance with some embodiments.

FIG. 5 shows an example of a segmented light emitting matrix control system.

Corresponding reference characters indicate corresponding parts throughout the several views. Elements in the drawings are not necessarily drawn to scale. The configurations shown in the drawings are merely examples and should not be construed as limiting the scope of the disclosed subject matter in any manner.

### DETAILED DESCRIPTION

As discussed above, LEDs are increasingly being used in handheld consumer products to illuminate not only places but often individuals. Flashlights typically use a small source size to reduce the optical components and provide a narrow beam illumination angle. Flashlights include, in some embodiments, handheld or body-mounted (e.g., head-mounted) lighting devices that may be communicatively-isolated devices; that is, such lighting devices are unable to communicate with other devices via cellular, WiFi, or other wireless communication protocols. The use of LEDs in flashlights has exploded due to the increased luminescence of LEDs. Flashlights that provide high brightness with a small LED source size may be used in a variety of indoor and outdoor uses. For example, outdoor recreational flashlight use includes handheld or body (e.g., head-mounted) use during camping, climbing, hiking, spelunking, running, and cycling, among other activities.

In some embodiments a lighting apparatus and method of controlling a lighting apparatus suitable for use in torch or general handheld device illumination are described. A power supply capable of supplying an amount of power is connected to an array of light emitting elements capable of illuminating an area in response to the supplied amount of power. At least some light emitting elements can have independently controllable illumination intensity, with the array of light emitting elements being switchable between a first mode in which each member of the array of light emitting elements received the supplied amount of power and provides a broadly collimated beam, and second mode where a subset of the array of light emitting elements receive the supplied amount of power and provides a narrower collimated beam.

In some embodiments, a torch or flashlight may have multiple arrays of LEDs in which each array is configured to emit light of a different wavelength (color). Each array may have independent optics to provide different beam emission angles. If the flashlight is stationary or moving at slow speeds, a relatively wide angle emission may be desired, whereas a high intensity narrow beam angle may be desired for maximum range if the flashlight is travelling at high speeds. This set of uses may be similar to low and high beam modes on car headlights and can be provided by adjustment of beam collimation through optical and/or pixel activation.

Some embodiments may use a single LED array on a monolithic die for creating an adaptive light source to minimize or even eliminate glare for individuals in the area under illumination by the LED array. Note that as used herein, the terms LED and pixel are used synonymously, unless otherwise noted. A camera or other sensor is used to identify a face being illuminated by the flashlight and turn off or otherwise adjust the appropriate pixels but still help to illuminate the overall area of interest. Positional sensors, including one or more orientation sensors (e.g., gyroscopes) and accelerometers, may be used to adjust the illumination or beam direction in response to LED array movement. An orientation sensor may be used to determine a direction of illumination or a direction that the flashlight is pointing, and additional sensors may be used to determine movement of the face. The processing circuitry may then turn off or reduce the intensity of pixels causing glare and perhaps activate alternate pixels to replace or supplement the affected pixels. An accelerometer can moreover be used to determine speed of the device and automatically adjust for low speed or high speed illumination modes.

In some embodiments, the device may have sets of predetermined illumination or collimation profiles that are automatically determined based on environmental conditions (e.g., day/night) and/or a determination based on image capture by the camera in the device. The illumination provided by the illumination or collimation profiles may be manually adjusted using user inputs on the device.

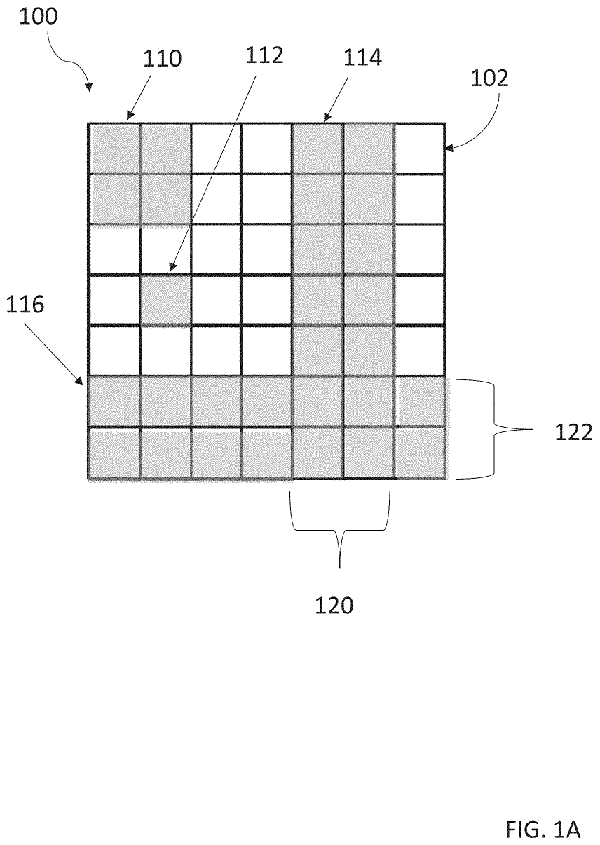

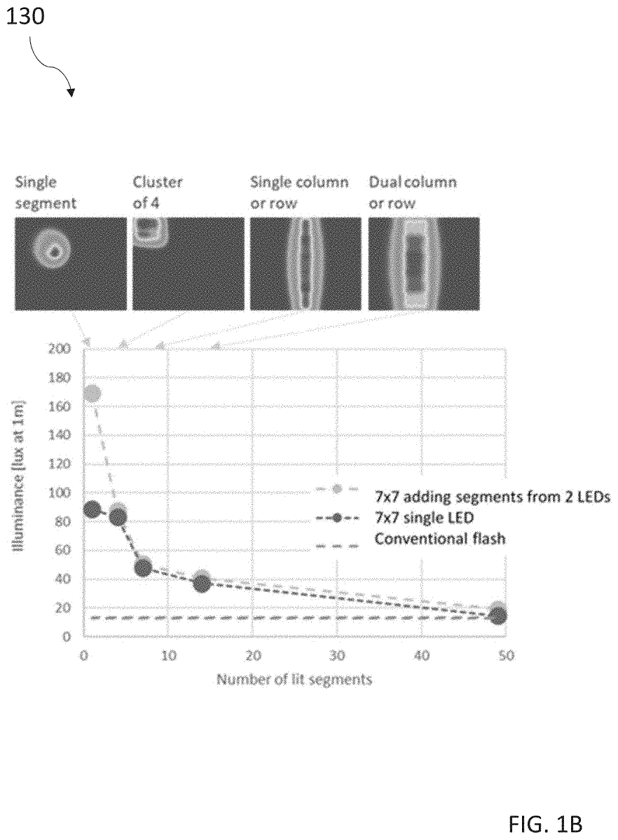

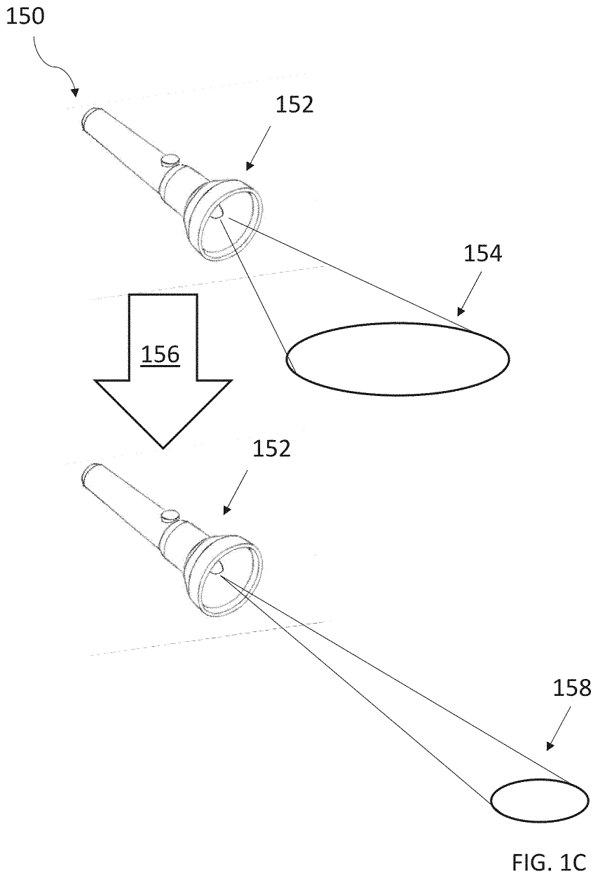

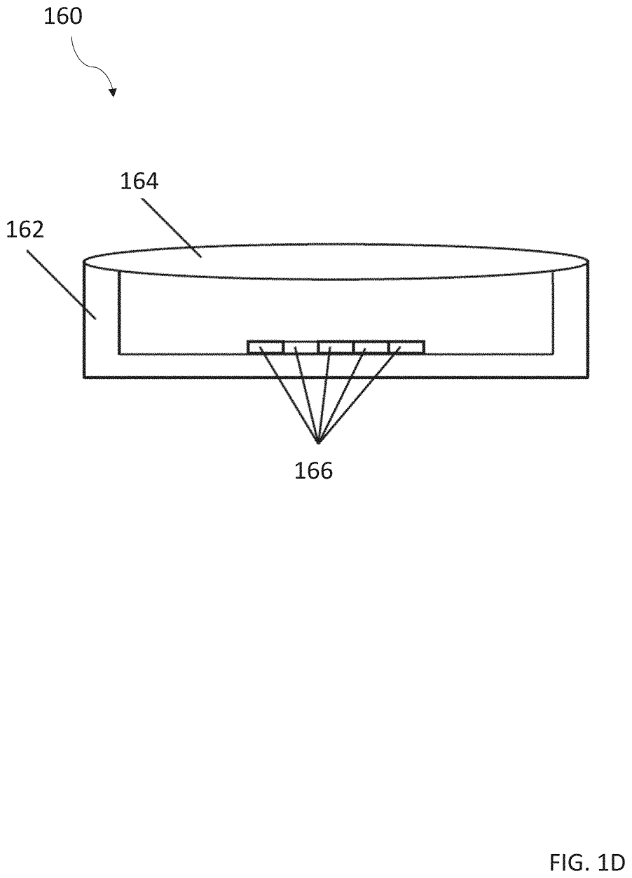

FIG. 1A shows a representative 7×7 LED array 100 suitable for a light source operated in various collimation modes. As shown, the light source may be a flashlight or electronic device in a smartphone used in flashlight mode. The light source may be used, for example, at night to illuminate an indoor or outdoor area. Using a segmented, individually addressable LED array with or without an imaging optics, superior illumination results in strobe or video can be achieved by illuminating the regions in scenes which require light and leaving out those which are sufficiently illuminated or too far away. When the available power is distributed over a smaller amount of cells, the local illumination can be substantially increased compared to switching on all pixels in the LED array.

In the illustrated embodiment, individual pixels 102 arranged as a 7×7 array can each be independently operated with full or partial control of light emitted by each pixel 102. Several possible operational modes are indicated. In a first mode, all pixels 102 can be equally powered to provide a wide and diffuse beam. In a second mode, a 2×2 sub-array 112 can be powered with substantially the same amount of electrical power as would be provided to all 7×7 pixels in the first mode. In effect, this will provide a narrow collimated beam having illumination can be increased by a factor of four (4), increasing the reach (distance) of the light source by a factor of two (2).

Other modes that use either less or more pixels, or have different geometrical arrangements of less, more, or the same number of pixels are also possible. For example, one pixel 112 can be activated, or a single line of pixels 114 or 116. Grouped pixel lines 120 or 122 are also possible. In some embodiments, activated pixels are clustered, contiguous and/or adjacent to each other. Different modes can be supported by various pixel placement options, including centered, at or near corners or sides of the pixel array, or even partially distributed checkerboard or similar patterns.

Some embodiments can use improved methods and structures for handling thermal loads. For example, in one embodiment array position of each member of the subset of the array of light emitting elements (e.g. pixels) is periodically changed to reduce thermal load. In other embodiments, a large substrate can be used to spread thermal load. In still other embodiments, a heat sink can be attached to a substrate to improve heat transfer characteristics. Substrates or heat sinks can be passively or actively cooled as necessary.

FIG. 1B is a graph 130 illustrating improved illumination for a 7×7 LED array operated in various collimation modes. As compared to the near constant illuminance as measured in lux at 1 meter, single or clusters of activated pixels can provide greatly increased illuminance.

FIG. 1C shows a switching a device 150 with a segment LED pixel array 152 between broad (beam 154) and narrow (beam 158) collimation modes. The device 150 can include various optics, such as diffusers, beam homogenizers, focusing elements, or diffraction elements. Switching modes (indicated by arrow 156) can be done manually or automatically. Manual activation can be by button, slide, or other touch switch mechanism, as well as by voice activation. Automatic switching can be based on environmental conditions as predicted or measured by local or remote sensors. In some embodiments, the device 150 can support additional features such as object or facial identification to permit either tracking (e.g. of an object) or preventing illumination (e.g. of a recognized face), as well as beam stabilized illumination of an object even when the device is slightly moved while being handheld. Beam stabilization can be achieved using motion detectors, gyroscopes, or accelerometers attached to the device that provide information necessary to quickly switch the illuminated pixels in response to device 150 movement.

FIG. 1D shows in cross section one embodiment of an LED pixel array device 160 including a housing 162, associated optic 164 for far field mixing, and an array of LED light emitters 166. The array of LED light emitters are independently operable, or arranged in groups of which are independently operable. LED pixel array device 160 also comprises a lens, lens system, or similar optical element 164 that collects light emitted by the array of LEDs and directs the collected light to provide an optical output beam from the light emitter. Optical element 164 may be positioned to image the LEDs in the array into the optical far field, for example.

The light beam emitted by LED pixel array device 160 may be steered by operation of subsets of the LEDs. For example, if only a first group of one or more LEDs at the right-hand side of the array as shown in the figure is operated, LED pixel array device 160 will produce an output beam that exits optical element 160 directed toward the upper left-hand side of the figure. If instead only a second group of one or more LEDs in the central portion of the array near or aligned with the optical axis of the optical element is operated, LED pixel array device 160 will produce an output beam that exits optical element generally along its optical axis, i.e., straight up in the figure. If instead only a third group of one or more LEDs at the left-hand side of the array as shown in the figure is operated, LED pixel array device 160 will produce an output beam that exits optical element 160 directed toward the upper right-hand side of the figure. Thus sequential operation of the first group, the second group, and then the third group of LEDs will steer the optical beam from the left to the right in the figure. The output beam may be similarly steered along more complicated paths by operation of subsets of the LEDs.

As further discussed below, such steering of the output beam may be used to compensate for motions of the light emitter (e.g., motions of a device of which the light emitter is a component) to maintain the aim of the beam on a desired target despite those motions. Alternatively, or in addition, an output beam from LED pixel array device 160 can provide for aiming the output beam from the device at a target, detecting a change in position, orientation, or position and orientation of the LED pixel array device 160 after aiming the output beam at the target. In other embodiments, operating the array of LED light emitters 166 will permit at least one of 1) steering the output beam to compensate for change in position, orientation, or position and orientation of the light emitting device, 2) maintaining the aim of the output beam on the target, and 3) altering collimation of the output beam by changing the number of LEDs operated to form the output beam.

The previously discussed collimation of the light beam emitted by LED pixel array device 160 may also be controlled by operation of subsets of the array of LED light emitters 166. For example, if in the above example the second group of LEDs includes a plurality of LEDs near or aligned with the optical axis of the optical element, the output beam will have a first collimation. If peripheral ones of that group of LEDs are turned off, with only the most central LEDs of the group operated, the collimation of the output beam will increase. That is, the cone angle of the output beam will decrease as will the beam diameter in the far field. This occurs because in the illustrated arrangement the collimation improves as light source area (number of LEDs in operation) decreases. Collimation may be varied in a similar manner for beams directed in other directions, away from the optical axis of the optical element. Collimation may be varied during steering of the beam.

The total optical output power in the beam may be maintained at a constant level while collimation is varied, by driving the group of operated LEDs with the same amount of electrical power regardless of the number of LEDs in the group. For example, if only a group of four LEDs is initially operated to provide an output beam and then two are turned off to improve collimation of the beam, the remaining two LEDs in operation may be operated at twice the power at which they were operated when all four LEDs in the group were operated. This will provide a more collimated beam with the same total optical power. The more collimated beam will appear brighter to an observer.

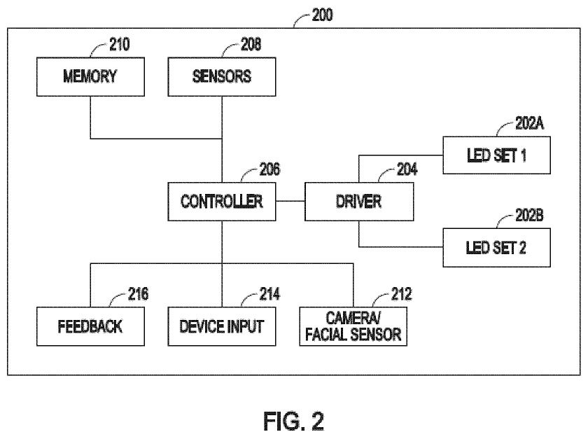

FIG. 2 shows circuitry in a light source in accordance with some embodiments. The light source 200 may be a specialized light source (e.g., flashlight) or may be part of a communication or computing device (e.g., smart phone, tablet/laptop computer) or another device, such as a digital camera. The light source 200 may include multiple sets of LEDs 202a, 202b driven by a driver 204 that is controlled by a controller 206, such as a microprocessor. The controller 206 may be coupled to sensors 208 and operate in accordance with instructions and profiles stored in a memory 210. The controller 206 may also be coupled to a camera or sensor 212, one or more input devices 214, and feedback circuitry 216. In some embodiments, the light source 200 may wirelessly communicate via Bluetooth, WiFi, LTE, or any other communication protocol using RF transceiver circuitry, while in other cases, the light source 200 may lack the RF transceiver circuitry or otherwise lack the ability to wirelessly communicate with other electronic devices using a communication protocol.

The sets of LEDs 202a, 202b may provide light at different wavelengths. For example, at least some of the sets of LEDs may provide different wavelengths of light for color tuning. For example, one set of LEDs 202a may provide white light while the other set of LEDs 202b may provide red light. The LEDs may be formed from a II-VI, III-V, or other compound semiconductor that may be a binary, ternary, quaternary, or other compound. For example, GaN is used for blue LEDs, GaAs for IR LEDs, and InGaP, InGaAlP, or InGaAsP for visible LEDs, among others. Alternatively, a wavelength converting structure may be disposed in the path of light extracted from the LED. The wavelength converting structure includes one or more wavelength converting materials which may be, for example, conventional phosphors, organic phosphors, quantum dots, organic semiconductors, II-VI or III-V semiconductors, II-VI or III-V semiconductor quantum dots or nanocrystals, dyes, polymers, or other materials that luminesce. The wavelength converting material includes light scattering or light diffusing elements, such as TiO₂, absorbs light emitted by the LED, and emits light of one or more different wavelengths. The light provided by the light source may be white, polychromatic, or monochromatic.

In some embodiments, the wavelength converting structure is a structure that is fabricated separately from the LED and attached to the LED, for example through wafer bonding or a suitable adhesive such as silicone or epoxy. One example of such a pre-fabricated wavelength converting element is a ceramic phosphor, which is formed by, for example, sintering powder phosphor or the precursor materials of phosphor into a ceramic slab, which may then be diced into individual wavelength converting elements. A ceramic phosphor may also be formed by, for example tape casting, where the ceramic is fabricated to the correct shape, with no dicing or cutting necessary. Examples of suitable non-ceramic pre-formed wavelength converting elements include powder phosphors that are dispersed in transparent material such as silicone or glass that is rolled, cast, or otherwise formed into a sheet, then singulated into individual wavelength converting elements, powder phosphors that are disposed in a transparent material such as silicone and laminated over the wafer of LEDs or individual LEDs, and phosphor mixed with silicone and disposed on a transparent substrate. The wavelength converting element need not be pre-formed. Instead, it may be, for example, wavelength converting material mixed with transparent binder that is laminated, dispensed, deposited, screen-printed, electrophoretically deposited, or otherwise positioned in the path of light emitted by the LEDs.

The wavelength converting structure need not be disposed in direct contact with the LEDs. In some embodiments, the wavelength converting structure is spaced apart from the LEDs.

The wavelength converting structure may be a monolithic element covering multiple or all LEDs in an array, or may be structured into separate segments, each attached to a corresponding LED. Gaps between these separate segments of the wavelength conversion structure may be filled with optically reflective material to confine light emission from each segment to this segment only.

As discussed above, one or more drivers 204 are used to drive the one or more sets of LEDs 202a, 202b. In some embodiments, for example, each set of LEDs 202a, 202b may be driven by a different driver 204. As a forward voltage of direct color LEDs decrease with increasing dominant wavelength, these LEDs can be driven with, for example, multichannel DC-to-DC converters. In addition, since light output of an LED is proportional to an amount of current used to drive the LED, dimming an LED can be achieved by, for example, reducing the forward current transferred to the LED. In addition to or instead of changing an amount of current used to drive each set of LEDs, a multiplexer, switching apparatus, or similar apparatus, may rapidly switch selected ones of the LEDs between “on” and “off” states to achieve an appropriate level of collimation, dimming, or illumination increase.

The driver 204 may thus be formed, for example, using either an analog-driver approach or a pulse-width modulation (PWM)-driver approach. When an analog driver is used, all LED sets that are driven together may be driven simultaneously. Each LED or LED set may be driven independently by providing a different current for each LED or LED set. In a PWM driver, each LED or LED set may be switched on, in sequence, at high speed and driven with substantially the same current. The color of the display may be controlled by changing the duty cycle of each color. In some embodiments, the current is supplied from a voltage-controlled current source.

The amount of current supplied and/or duty cycle may be controlled, as indicated above, by the controller 206. The controller 206 may be a microprocessor that includes, for example, an application processor and a baseband processor. Sensors 208 may include, for example, positional sensors (e.g., a gyroscope and/or accelerometer) and/or other sensors that may be used to determine the position, speed, and orientation of the light source 200. The signals from the sensors 208 may be supplied to the controller 206 to be used to determine the appropriate course of action of the controller 206 (e.g., which LEDs are currently illuminating the face and which LEDs will be illuminating the face a predetermined amount of time later).

The memory 210 may be nonvolatile memory. The memory 210 may store instructions and applications used by the controller 206 to control driving of the LED sets 202a, 202b by the driver 204 based on particular profiles also stored therein. The instructions may take into account input from the various sensors 208 as well as from the camera/sensor 212. The applications may include facial detection and recognition used to determine the presence of a face within the direction of illumination of the LEDs of the LED sets 202a, 202b. This allows, for example, the beam to be switched off or redirected away from a person's face. Alternatively, or in addition, an application can include beam stabilization achieved using motion detectors, gyroscopes, or accelerometers attached as sensors 208 that provide information necessary to quickly switch the illuminated pixels in response to light source 200 movement.

The facial detection may use a simple facial detection algorithm or a more complicated face recognition algorithm, such as the face recognizer in the OpenCV library, to determine the presence of (or even identify) which pixels are illuminating a face.

The camera/sensor 212 may include multiple photodiodes that are configured to detect wavelengths at and near the wavelengths provided by at least one of the LED sets 202a, 202b. For example, the camera/sensor 212 may be an IR camera that detects IR radiation emitted by one of the LED sets 202a, 202b and that is reflected by an individual face.

One or more device inputs 214 may include, for example, a user-activated input device such as a button that a user presses to activate the light source or take a picture. In some embodiments, the device input 214 may be a mechanical switch or an electronic switch that is attached to a sensor to provide haptic feedback. The device input 214 may be disposed on the light source 200. Similarly, the feedback circuitry 216 may provide feedback (e.g., visual, audible and/or tactile feedback) when the controller 206 determines that light of a particular set of the LEDs 202a of the light source 200 impinges on a face (i.e., facial illumination by the particular set of the LEDs 202a).

The controller 206 may be any microprocessor capable of executing instructions (sequential or otherwise) that specify actions to be taken. The light source 200 may contain logic and various components and modules on which the controller 206 may operate, as described above. Modules and components are tangible entities (e.g., hardware) capable of performing specified operations and may be configured or arranged in a certain manner. In an example embodiment, circuits may be arranged (e.g., internally or with respect to external entities such as other circuits) in a specified manner as a module. The controller 206 may be configured by firmware or software (e.g., instructions, an application portion, or an application) as a module that operates to perform specified operations. In an example embodiment, the software may reside on a machine readable medium, such as a non-statutory machine readable medium. In an example embodiment, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may, accordingly, configure a hardware processor, for example, to constitute a particular module at one instance of time and to constitute a different module at a different instance of time.

If the light source 200 contains multiple memories 210, some or all of the memories 210 may communicate with each other via an interlink (e.g., bus) (hereafter referred to as a memory for convenience). The memory 210 may be removable storage, non-removable storage, volatile memory, and/or non-volatile memory. The memory 210 may include a non-transitory machine readable medium on which is stored one or more sets of data structures or instructions (e.g., software) embodying or utilized by any one or more of the techniques or functions described herein. The instructions may also reside, successfully or at least partially, within the controller 206 during execution thereof by the controller 206. The machine readable medium may be a single medium, the term “machine readable medium” may include a single medium or multiple media (e.g., a centralized or distributed database, and/or associated caches and servers) configured to store the one or more instructions.

The term “machine readable medium” may include any medium that is capable of storing, encoding, or carrying instructions for execution by the controller 206 and that cause the controller 206 to perform any one or more of the methods described herein, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks.

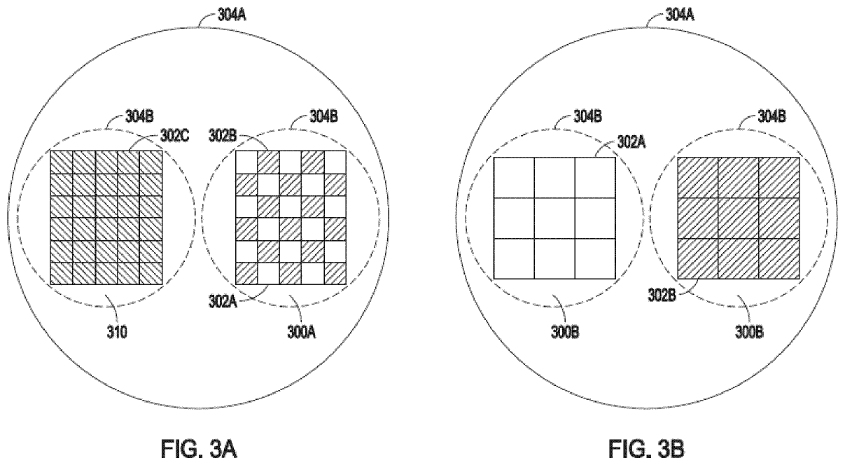

FIGS. 3A-3B show LED arrays in accordance with some embodiments. The LED array 300a shown in FIG. 3A or LED arrays 300b shown in FIG. 3B may be disposed in the devices discussed in relation to FIGS. 1 and 2. As shown, each LED array 300a, 300b may have multiple LEDs (pixels) 302a, 302b. In some embodiments, pixels can be of uniform shape and size, while in other embodiments shape and size can be selected as needed. As shown, each LED array 300a, 300b may be formed in a rectangular m×n pixel matrix, where m and n are non-zero integers. The integers m and n may be different, as shown in FIG. 3A, or may be the same, as shown in FIG. 3B. In other embodiments, the LED array 300a, 300b may be formed or otherwise fabricated in a shape approximating a non-rectangular (e.g., circular or oval) shape. Each pixel 302a, 302b may be a single color, with the colors being different (e.g., pixels 302a emitting white light and pixels 302b emitting red light). Although the different color pixels 302a, 302b shown in FIG. 3A are interleaved, in other embodiments, the different color pixels 302a, 302b may have other groupings in which groups of one color are disposed together in one or both orthogonal directions.

Each LED array 300a, 300b may have optics 304a, 304b (one or more optical element(s)) that direct light from the LED array 300a, 300b in a particular direction. In FIG. 3A, due to the interspersed nature of the LED array 300a, one or more optical elements 304a may be used. In some embodiments, LEDs with interleaved segments of different colors can also include an interleaved array with inversed color arrangement in 310, allowing combination to target color in the far field. High resolution embodiments can include three or more colors. In FIG. 3B, a one or more optical elements 304a may be used for both LED arrays 300b or each LED array 300b may have a different optical element 304b. In the latter case, the use of multiple optical elements 304b may allow individual guiding of the light from each LED array 300a, 300b to illuminate the same location. The optical element 304a may include one or more of, for example, a lens, a Fresnel lens, a refractive lens, a total internal reflection lens, a reflector, a collimator, or any other suitable optic.

In other embodiments, the optics may be individualized so that optical elements are built into each pixel or may be associated with groups of pixels (e.g., each optical element provided for multiple pixels) within each LED array 300a, 300b. In some embodiments, the optics may be a mixture of individualized and associated with groups of pixels (e.g., pixels at edges of the pixel matrix being provided with one optical element).

A sensor or imaging system (camera) 310 that contains multiple photodiodes may be used to obtain an image under illumination by the LED array 300a, 300b. The sensor 310 may be disposed adjacent to the LED array(s) 300a. Similar to the above, the sensor 310 may use the optical element 304a used by the LED array 300a, which covers both the LED array 300a and the sensor 310 or may use a different optical element 304b than the LED array 300a. In this case, one of the optical elements 304b may direct light from the LED array 300a in a particular direction and the other of the optical elements 304b may direct light from the particular direction to the sensor 310.

The sensor 310 may thus be used to capture the face of an individual (among other aspects of the field of view), while the controller 206 shown in FIG. 2 may be used to identify that the face is present. The speed and orientation sensors 208 shown in FIG. 2 may further be used by the controller 206 to estimate where the light from the pixels 302a, 302b of the LED array 300a (or LED arrays 300a, 300b) is to be directed in advance. Such a calculation may be performed after initial facial detection to allow adjustment of at least pixels 302a illuminating the face without, or in advance of, further image capture by the sensor 310 and facial detection (and processing) by the controller 206. By determining in advance whether, and perhaps which of, the pixels 302a are to illuminate the face, the amount of time of facial illumination by light from the pixels 302a may be reduced.

In some embodiments, once facial detection has occurred, illumination from all of the pixels 302a of the LED array 300a may be adjusted—deactivated or the intensity of illumination of the pixels 302a may be reduced by a significant predetermined percent (e.g., between about 50% and about 90%). In various embodiments, the adjustment may occur for a predetermined amount of time, until manually overridden by the user, or until the face is no longer detected or calculated to be detected as described above. Alternatively, the controller 206 may limit adjustment over time to only those pixels 302a (e.g., the number of pixels emitting white light) illuminating the face, while continuing to use others of the pixels 302a at normal operating conditions (e.g., maximum illumination). The adjustment may occur, as indicated above, for a predetermined amount of time, until manually overridden by the user, or until the face is no longer detected or calculated to be detected as described above.

Regardless of whether illumination from all, or merely some, of the pixels 302a of the LED array 300a are adjusted, illumination from some or all of the other pixels 302b (within the same LED array 300a, if present, or in the separate LED array 300b) may or may not also be adjusted. That is, some or all the other pixels 302b, may be activated, if inactive when the pixels 302a are active, the intensity of illumination of the other pixels 302b may be increased by a significant predetermined percent (e.g., between about 50% and about 90%), or the intensity of illumination of the other pixels 302b may be unaffected by adjustment of the pixels 302a. In the latter case, the other pixels 302b may thus provide light at the same time and in the same place as light from the pixels 302a. If the intensity of illumination of the other pixels 302b is adjusted based on adjustment of the intensity of illumination of the pixels 302a, various embodiments may be used as described above. In such embodiments, the adjustment of all or some of the other pixels 302b may occur for a predetermined amount of time, until manually overridden by the user, or until the face is no longer detected or calculated to be detected as described above. When only some of the other pixels 302b are adjusted, the controller 206 may limit the adjustment over time to only those other pixels 302b (e.g., the number of pixels emitting red light) illuminating the face.

The controller 206 may thus deactivate or reduce the intensity of pixels 302a of the first color (e.g., white) under facial detection conditions and use alternate pixels 302b of the second color (e.g., red) to replace or supplement at least the affected pixels 302a of the first color. Although red light may be used, any second color that is less irritating may be selected. Note that multiple sets of LEDs may be used to form the first color and/or the second. That is, multiple sub-pixels may be used to form a pixel 302a of the first color to provide light with a particular CCT and Duv (defined in ANSI C78.377 as the distance from the BBL). In some cases, when white light is formed by an RGB combination of sub-pixels, the GB sub-pixels may be adjusted as described above in relation to the pixels 302a of the first color and the R sub-pixels may be adjusted as described above in relation to the pixels 302b of the second color.

In some embodiments, beam shaping may be provided by selecting pixels to be activated. For example, lighting sources, such as flashlights, may use a lens. The focus of the lens may be able to be adjusted, e.g., by rotation of the lens to make the beam narrower or broader. On a flashlight, for example, the cap may be rotated to produce this effect. In the embodiments described herein, beam focus or steering can also be performed electronically with a monolithic array of pixels, by activation of one or more subsets of the pixels, to permit dynamic adjustment of the beam shape without moving optics or changing the focus of the lens in the lighting apparatus. Such an embodiment, for example, may be based on different optics (with different characteristics) being provided for the different subsets of the pixels. In other embodiments, the beam focus or steering can be based on both activation of one or more subsets of the pixels and movement/focal change of the optics. As described, the beam shaping may be activated using manual interaction with the light apparatus, such as activation of a switch or button. In addition, or instead, the beam shaping may be activated using feedback from the environment detected by one or more sensors in the lighting apparatus. Examples of such feedback include, but are not limited to, distance to the object being illuminated and/or ambient lighting, audible commands (as determined using voice recognition software such as that provided by Dragon of Google), or electronically entered using a remote source, e.g., a smartphone, using an App if the lighting apparatus is able to communicate wirelessly. Still other applications can include navigation assistance, bicycle road light assisting, or personal in home, office, or store guidance.

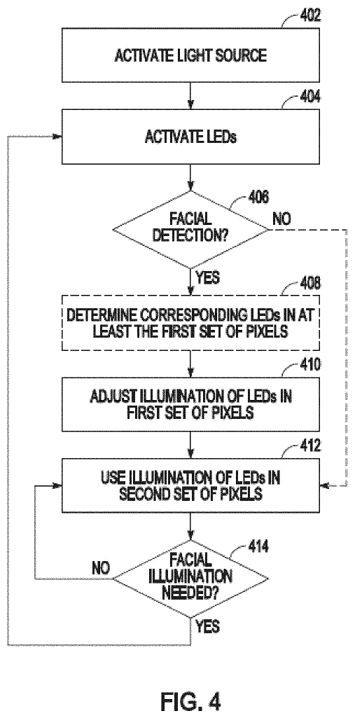

FIG. 4 shows an example of a flowchart of using a light source in accordance with some embodiments. The light source may be any of the light sources discussed above. The method may include one or more operations, functions, or actions illustrated by one or more blocks. Although the blocks are illustrated in sequential orders, these blocks may also be performed in parallel and/or in a different order than those described herein. Also, the various blocks may be combined into fewer blocks, divided into additional blocks, and/or eliminated based upon the desired implementation.

At operation 402, the light source is activated by the user. The activation may be manual, such as by a switch. Alternatively, if the light source is capable of wireless communication, the activation may triggered via another device, such as a smartphone.

At operation 404, the LEDs are activated. The LEDs activated include a first set of LEDs of the normal color (e.g., white) used by the light source. In some embodiments, a second set of LEDs of another color (e.g., red) may be activated at this point, or may remain deactivated. As described above, the active LEDs and inactive LEDs may be disposed on a single array in an interspersed manner or may be disposed on different arrays. Light from the array(s) may be directed by a single optical element (e.g., lens) or each array, if multiple arrays are present, may be associated with a different optical element. Independent of whether a single optical element or multiple optical elements are used, light from both sets of LEDs are directed to the same location by the optical element(s).

At operation 406, the controller in the light source determines whether a face is detected. The determination is based on signals from the sensor/camera, which may be provided on a separate array from the array(s) containing the active and inactive LEDs. The sensor/camera, like the array(s), may use the same optical element or a different optical element as the sets of LEDs to capture an image illuminated by the light source. Light from the first set of LEDs reflected back towards the sensor may be directed by the optical element to the sensor.

At operation 408, the controller may determine the LEDs illuminating the face. The determination is again based on signals from the sensor/camera. The corresponding LEDs may be only those in the first set of LEDs or may include those in the second set of LEDs.

At operation 410, the controller may adjust illumination provided by the first set of LEDs by adjusting the amount of current provided by the drivers associated with the first set of LEDs. The adjustment may be deactivation of the first set of LEDs or of only the corresponding LEDs of the first set of LEDs. Alternatively, the adjustment may be reduction of the driving current provided by the driver, thereby reducing the illumination provided by the first set of LEDs or of only the corresponding LEDs of the first set of LEDs. The reduction may be to a predetermined intensity or may be by a predetermined percentage. In some embodiments, the intensity may be adjusted based on the environment (e.g., daylight/nighttime). Note that operation 408 may be omitted if the adjustment is to all of the first set of LEDs.

After adjustment of the illumination provided by LEDs in the first set of LEDs, at operation 412, the light source uses illumination provided by the LEDs in the second set of LEDs. In some embodiments, the second set of LEDs may already be active, and thus no adjustments may be made. In other embodiments, either the second set of LEDs may be inactive and at least some of the LEDs of the second set of LEDs may be activated by adjusting the amount of current provided by the drivers associated with the second set of LEDs. The activated LEDs include at least those corresponding to the LEDs illuminating the face. The adjustment may also include increasing the light provided by the second set of LEDs, if already active.

At operation 414, the controller determines whether facial illumination has ended. This may be determined via the signals from the sensor/camera, estimated from speed and orientation signals from the other sensors in the light source, or due to manual interaction with the light source. If so, the method returns to operation 404 to re-adjust illumination of the LEDs in the first set of LEDs. If not, the method returns to operation 412, perhaps adjusting whichever of the first set and second set of LEDs are adjusted based on the signals from the sensor/camera or estimated from speed and orientation signals from the other sensors in the light source.

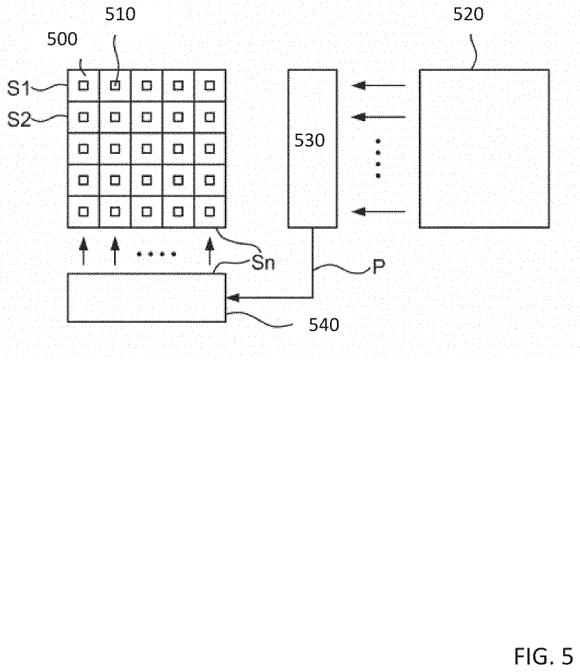

FIG. 5 illustrates another embodiment of a segmented or matrix pixel array that includes dedicated control systems for individual LED pixel control and that can be adjusted in response to detection of a face or other object. A segmented light element 500 includes a 5×5 square array of LEDs 500. A camera connected illumination mapping module 520 is able to receive face related information and provide data to a beam steering illumination controller 530. The beam steering illumination controller 530 can use a suitable processing technique to compute an illumination profile P from the feedback provided by the camera or image sensor and forward this to a controller 540. The illumination profile P specifies the required intensity or power required for each LED 510 to correctly illuminate an area or sub-area of a scene, using a signal Sn provided to specific LEDs or groups of LEDs. In certain embodiments, the illumination profile P computed by a suitable processor unit can further be stored in memory.

In operation, a segmented matrix of light emitting devices (LEDs) illuminates an area, with at least some LEDs having independently controllable illumination intensity to allow for differential illumination of sub-areas in a scene or area. The beam steering controller is configured to receive data indicating location of a human face in the area and reduce illumination from the segmented matrix of light emitting devices in the particular sub-area illuminating the human face. Data indicating presence of a human face can be provided by an image sensor, or optical (e.g. laser scanning) or non-optical (e.g. millimeter radar) depth sensors.

Any suitable light sources—or any suitable combination of different light sources—may be used in a segmented light matrix. For example, semiconductor light sources such as light-emitting diodes (LEDs) or vertical cavity surface emitting lasers (VCSELs) can be used. For an application such as a flashlight, for example, the total power of the LEDs may be in the region of 0.1 to 10 W, and any suitable sized array may be used, for example a 3×3 array, a 5×5 array, a 15×21 array, etc. The array shape can be square, rectangular, circular, etc. The emitters of the segmented flash can emit in the visible range but may alternatively emit in the infrared or ultraviolet range, depending on the application. In some embodiments, LED or VCSEL segment size can range from hundreds of microns to sub-millimeter.

Light emitting matrix pixel arrays such as described herein may support various other beam steering or other applications that benefit from fine-grained intensity, spatial, and temporal control of light distribution. This may include, but is not limited to, precise spatial patterning of emitted light from pixel blocks or individual pixels. Depending on the application, emitted light may be spectrally distinct, adaptive over time, and/or environmentally responsive. The light emitting pixel arrays may provide pre-programmed light distribution in various intensity, spatial, or temporal patterns. Associated optics may be distinct at a pixel, pixel block, or device level. An example light emitting pixel array may include a device having a commonly controlled central block of high intensity pixels with an associated common optic, whereas edge pixels may have individual optics. In addition to flashlights, common applications supported by light emitting pixel arrays include video lighting, automotive headlights, architectural and area illumination, and street lighting.

For example, light emitting matrix pixel arrays may be used to selectively and adaptively illuminate buildings or areas for improved visual display or to reduce lighting costs. In addition, light emitting pixel arrays may be used to project media facades for decorative motion or video effects. In conjunction with tracking sensors and/or cameras, selective illumination of areas around pedestrians may be possible. Spectrally distinct pixels may be used to adjust the color temperature of lighting, as well as support wavelength specific horticultural illumination.

Street lighting is an important application that may greatly benefit from use of light emitting pixel arrays. A single type of light emitting array may be used to mimic various street light types, allowing, for example, switching between a Type I linear street light and a Type IV semicircular street light by appropriate activation or deactivation of selected pixels. In addition, street lighting costs may be lowered by adjusting light beam intensity or distribution according to environmental conditions, presence or absence of pedestrians as identified by facial recognition, or time of use. For example, light intensity and area of distribution may be reduced when pedestrians are not present. If pixels of the light emitting pixel array are spectrally distinct, the color temperature of the light may be adjusted according to respective daylight, twilight, or night conditions.

Vehicle headlamps are another light emitting array application that requires large pixel numbers and a high data refresh rate. Automotive headlights that actively illuminate only selected sections of a roadway can used to reduce problems associated with glare or dazzling of oncoming drivers. Using infrared cameras as sensors, light emitting pixel arrays activate only those pixels needed to illuminate the roadway, while deactivating pixels that may dazzle pedestrians or drivers of oncoming vehicles. In some embodiments, off-road pedestrians, animals, or signs may be selectively illuminated to improve driver environmental awareness. If pixels of the light emitting pixel array are spectrally distinct, the color temperature of the light may be adjusted according to respective daylight, twilight, or night conditions.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

It should be appreciated that the electrical circuits of the accompanying drawings and its teachings are readily scalable and can accommodate a large number of components, as well as more complicated/sophisticated arrangements and configurations. Accordingly, the examples provided should not limit the scope or inhibit the broad teachings of the electrical circuits as potentially applied to a myriad of other architectures.

In some embodiments, any number of electrical circuits of the accompanying drawings may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), computer-readable non-transitory memory elements, etc. can be suitably coupled to the board based on particular configuration needs, processing demands, computer designs, etc. Other components such as external storage, additional sensors, controllers for audio/video display, and peripheral devices may be attached to the board as plug-in cards, via cables, or integrated into the board itself. In various embodiments, the functionalities described herein may be implemented in emulation form as software or firmware running within one or more configurable (e.g., programmable) elements arranged in a structure that supports these functions. The software or firmware providing the emulation may be provided on non-transitory computer-readable storage medium comprising instructions to allow a processor to carry out those functionalities.

In some embodiments, the electrical circuits of, or associated with, the accompanying drawings may be implemented as stand-alone modules (e.g., a device with associated components and circuitry configured to perform a specific application or function) or implemented as plug-in modules into application specific hardware of electronic devices. Note that some embodiments of the present disclosure may be readily included in a system on chip (SOC) package, either in part, or in whole. An SOC represents an integrated circuit (IC) that integrates components of a computer or other electronic system into a single chip. It may contain digital, analog, mixed-signal, and often radio frequency functions: all of which may be provided on a single chip substrate. Other embodiments may include a multi-chip-module (MCM), with a plurality of separate ICs located within a single electronic package and configured to interact closely with each other through the electronic package. In various other embodiments, at least some aspects of controlling LED arrays with self-stabilizing torch functions may be implemented in one or more silicon cores in Application Specific Integrated Circuits (ASICs), Field Programmable Gate Arrays (FPGAs), and other semiconductor chips.

It is also important to note that the functions related to LED arrays with self-stabilizing torch or flashlight functions illustrate only some of the possible functions that may be executed by, or within, the hand-held, portable, or mounted devices as described herein. Some of these operations may be deleted or removed where appropriate, or these operations may be modified or changed considerably without departing from the scope of the present disclosure. In addition, the timing of these operations may be altered considerably. The preceding operational flows have been offered for purposes of example and discussion. Substantial flexibility is provided by embodiments described herein in that any suitable arrangements, chronologies, configurations, and timing mechanisms may be provided without departing from the teachings of the present disclosure.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. Note that all optional features of any of the devices and systems described herein may also be implemented with respect to the methods or processes described herein and specifics in the examples may be used anywhere in one or more embodiments.

What is claimed is:

1. A lighting apparatus comprising:
a power supply capable of supplying an amount of power;
an array of light emitting elements capable of illuminating an area in response to the supplied amount of power, with at least some light emitting elements having independently controllable illumination intensity, wherein the array of light emitting elements are switchable between a first mode in which each member of the array of light emitting elements receive the supplied amount of power and provides a broadly collimated beam, and second mode where a subset of the array of light emitting elements receive the supplied amount of power and provides a narrower collimated beam.

2. The lighting apparatus of claim 1, wherein in the first mode each member of the array of light emitting elements receives an equal fraction of the supplied amount of power.

3. The lighting apparatus of claim 1, wherein in the second mode each member of the subset of the array of light emitting elements receives an equal fraction of the supplied amount of power.

4. The lighting apparatus of claim 1, wherein each member of the subset of the array of light emitting elements is contiguous.

5. The lighting apparatus of claim 1, wherein array position of each member of the subset of the array of light emitting elements is periodically changed to reduce thermal load.

6. The lighting apparatus of claim 1, wherein presence of the human face is detected by an image sensor.

7. The lighting apparatus of claim 1, wherein movement of the lighting apparatus is detected by lighting apparatus mounted motion detectors.

8. The lighting apparatus of claim 1, wherein each segment of the segmented matrix of light emitting elements is sized to be between 100 microns and 1 millimeter.

9. The lighting apparatus of claim 1, wherein the segmented matrix of light emitting elements further comprises at least one of a light emitting device (LED) or a VCSEL.

10. The lighting apparatus of claim 1, wherein switching between the first mode and the second mode is manual.

11. The lighting apparatus of claim 1, wherein switching between the first mode and the second mode is automatic.

12. The lighting apparatus of claim 1, wherein a number of light emitting elements supplied with power in the second mode includes less than one-half of the light emitting elements.

13. The lighting apparatus of claim 1, wherein a number of light emitting elements supplied with power in the second mode includes less than one-tenth of the light emitting elements.

14. The lighting apparatus of claim 1, wherein a number of light emitting elements supplied with power in the second mode defines at least one of a square, a rectangle, or a line with contiguous light emitting elements.

15. A method of controlling a lighting apparatus, the method comprising:
activating in first mode a set of LEDs of the lighting apparatus to provide light with a first broad collimation;
activating in a second mode a subset of LEDs of the lighting apparatus to provide light with a second narrower collimation, wherein power supplied in the first mode is the same as power supplied in the second mode.

16. The method of claim 15, further comprising: electronically determining that the lighting apparatus is illuminating a human face.

17. The method of claim 15, further comprising: electronically determining that the lighting apparatus is being moved.

18. A method of operating a light emitting device comprising an array of LEDs configured to provide an output beam from the device, the method comprising:
aiming the output beam from the device at a target;
detecting a change in position, orientation, or position and orientation of the light emitting device after aiming the output beam at the target;
operating the array of LEDs to at least one of 1) steer the output beam to compensate for change in position, orientation, or position and orientation of the light emitting device, 2) maintain the aim of the output beam on the target, and 3) alter collimation of the output beam by changing the number of LEDs operated to form the output beam.

19. The method of claim 18, comprising forming the output beam with an optical element that collects light emitted by the LEDs.

20. The method of claim 18, comprising independently operating LEDs or groups of LEDs in sequence to steer the output beam.
